(19) United States
(12) Patent Application Publication
(10) Pub. No.: US 2008/0026186 A1
(43) Pub. Date: Jan. 31, 2008

(54) Hot-Melt Adhesive

(75) Inventors: Marc Husemann, Hamburg (DE); Renke Bargmann, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: tesa AG, Hamburg (DE)

(21) Appl. No.: 10/578,231

(22) PCT Filed: Dec. 21, 2004
(86) PCT No.: PCT/EP04/53629

§ 371 Date: Feb. 2, 2007

(30) Foreign Application Priority Data
Dec. 23, 2003 (DE) 103 61 538.5

(51) Int. Cl. C09J 7/00; C09J 5/06

(52) U.S. Cl. 428/172; 156/60; 427/208.2; 428/346

(57) ABSTRACT

An adhesive sheet composed of a thermoplastic and optionally one or more resins, wherein

a) the adhesive system has a softening temperature of greater than 65° C. and less than 125° C.,

b) a melt flow index (ISO 1133) of greater than 3 and less than 100 cm³/10 minutes,

c) a storage modulus G′ at 23° C., as measured by test method A, of greater than 10⁷ Pas,

d) a loss modulus G″ at 23° C., as measured by test method A, of greater than 10⁶ Pas,

e) and a crossover, as measured by test method A, of less than 125° C.

The invention relates to a thermoplastic hot-melt adhesive optionally with reactive resin, which is activated at implanting temperatures of 150° C. and is used for bonding electrical modules to card bodies.

In relation to the implanting of electrical modules in card bodies the prior art has already disclosed a multiplicity of adhesive sheets or joining methods. The aim of such implantations is to produce telephone cards, credit cards, parking machine cards, insurance cards, etc. Examples of the corresponding adhesive bonding methods are found for example in patents EP 0 842 995 A, EP 1 078 965 A, and DE 199 48 560 A.

In this field of adhesive bonding, however, the bar is continuously being raised as regards the requirements imposed on the adhesive system. For instance, the adhesive must adhere well to polycarbonate, to ABS, PVC, and PET, and also to the electrical module. Bonding here is generally to epoxy materials, polyesters or polyimides. At one time cyano acrylates were used as liquid adhesives, and have the advantage of optimum wetting of both the card body and the electrical chip. This technology, however, is dying out, since the operations are very slow. The evaporation of the solvent from the cavity in the card body was slow; the metering nozzles became blocked during downtime, as a result of drying out, and were also of poor meterability; and the liquid adhesive likewise required a certain time for curing. As a result, the quality of adhesive bonding was decidedly poor.

It is here that the hot-melt adhesives prove markedly superior to their liquid counterparts. Nevertheless, here as well, the selection of suitable compounds is very limited, owing to the exacting requirements imposed on this joining technique. One restriction involves the very different materials that must be bonded. Owing to the very different polarities of PC, PVC, PET, ABS, epoxy, and polyimide, it is impossible to find a single polymer which adheres equally well to all materials.

Moreover, the requirements imposed by the end customers are rising further and further. For example, the flatness of the electrical module with the card body is an important criterion, since otherwise it would no longer be possible to read the cards. This implies an upper limit on the implanting temperatures, since, for example, PVC in particular tends to deform at implanting temperatures above 170° C.

Another criterion is the requirement from the banking sector that the electrical modules should not be able to be removed without destruction. Accordingly the internal cohesion of the adhesive must be very high, so that it does not split in the middle and the adhesion to either side (card body+electrical module) is extremely high. At the same time, however, the adhesive must also have a very high flexibility, since following implantation the cards pass through torsion tests and a flexural test. Preferably the card material ought to break before any failure of adhesion to the card body and to the electrical module. In general not even instances of lifting at the edge are tolerated.

A further criterion are temperature fluctuations and the effect of moisture, since in the course of their subsequent use these cards must withstand both high and low temperatures and in some cases are even required to survive a transit through the wash. Accordingly, the adhesive ought not to become brittle at low temperatures, ought not to liquefy at high temperatures, and ought to possess a low propensity to absorb water.

A further requirement criterion, owing to the growing numbers of card demand, is the processing speed. The adhesive ought to soften or melt very quickly, so that the implanting operation can be concluded within a second.

The object on which the invention is based, in view of this prior art, is that of specifying an adhesive sheet for implanting electrical modules in a card body, the said sheet meeting the criteria specified above and developing very high adhesion to the different card bodies and electrical modules in the die in particular at implanting temperatures of 150° C.

In accordance with the invention the object is achieved by means of an adhesive sheet composed of a thermoplastic and optionally one or more resins, wherein the adhesive system
a) has a softening temperature of greater than 65° C. and less than 125° C.,
b) a melt flow index of greater than 3 and less than 100 cm³/10 minutes (measured in analogy to ISO 1133 at T=150° C. and 2.16 kg),
c) a storage modulus G′ at 23° C., as measured by test method A, of greater than 10⁷ Pas,
d) a loss modulus G″ at 23° C., as measured by test method A, of greater than 10⁶ Pas,
e) and a crossover (identity of storage modulus with loss modulus), as measured by test method A, of less than 125° C.

The temperature-activable adhesive system, by virtue of the Theological properties, has an optimized flow behavior.

Furthermore, the crossover temperature must be below 125° C., since otherwise the adhesive will not become fluid and hence would not provide optimum wetting either of the card surface or of the electrical module. At the crossover point there is intersection of the storage modulus G′ and loss modulus G″ curves; physically this can be interpreted as the transition from elastic to viscous behavior.

Furthermore, the elastic component, i.e., the storage modulus G′, must be greater than 10⁷ Pas, and the viscous component, i.e., the loss modulus G″, must be greater than 10⁶ Pas, since otherwise the adhesive is not ensured optimum flexibility. The adhesive must ensure the loadings that occur between card body and electrical module even under instances of severe distortion. Hence the need for a Theologically optimized viscoelastic behavior.

The melt flow index must be between 3 and 50 cm³/10 minutes. At a figure of less than 3 cm³/10 minutes, the card surface is not adequately wetted. At figures of greater than 50 cm³/10 minutes, the adhesive is squeezed out during implanting.

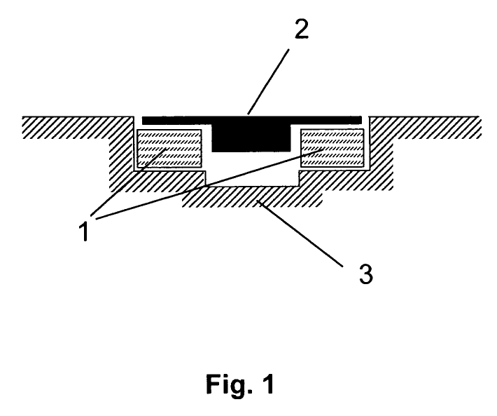

The adhesive bonding of the electrical module 2 to a card body 3 is depicted diagrammatically in FIG. 1). The inventive temperature-activable adhesive 1 possesses a layer thickness of between 10 and 100 μm in one preferred version and a layer thickness of 30 to 80 μm in a particularly preferred version.

### Heat-Activable Adhesive

The heat-activable adhesive serves in particular as an adhesive sheet for bonding electrical chip modules in card bodies, the respective adhesive layer developing very good adhesion to the card body and to the electrical chip module following temperature activation.

For the bonding of the electrical module, the heat-activable adhesive possesses good adhesion to epoxy materials, polyesters, and polyimides, and for bonding to card bodies it possesses good adhesion to PC, ABS, PVC, and PET. In one very preferred version thermoplastic materials are employed for this purpose, such as polyurethanes, polyesters, polyamides, ethylene-vinyl acetates, synthetic rubbers, such as styrene isoprene diblock and triblock copolymers (SIS), styrene-butadiene diblock and triblock copolymers (SBS), styrene-ethylene-butadiene diblock and triblock copolymer (SEBS), polyvinyl acetate, polyimides, polyethers, copolyamides, copolyesters, polyolefins, such as polyethylene, polypropylene, or poly(meth)acrylates, for example. The enumeration makes no claims of completeness.

The polymers possess a softening range of between 65 and 125°.

To optimize the technical adhesive properties and the activation range it is possible to add bond strength-enhancing resins or reactive resins. The proportion of the resins is between 2% and 50% by weight based on the thermoplastic.

Tackifying resins for addition that can be used include, without exception, all tackifier resins that are already known and described in the literature. Representatives that may be mentioned include the pinene resins, indene resins, and rosins, their disproportionated, hydrogenated, polymerized, and esterified derivates and salts, the aliphatic and aromatic hydrocarbon resins, terpene resins, and terpenephenolic resins, and also C5, C9, and other hydrocarbon resins. Any desired combinations of these and further resins may be used in order to adjust the properties of the resultant adhesive in accordance with requirements. Generally speaking it is possible to use all resins that are compatible with (soluble in) the thermoplastic; reference may be made in particular to all aliphatic, aromatic, and alkylaromatic hydrocarbon resins, hydrocarbon resins based on single monomers, hydrogenated hydrocarbon resins, functional hydrocarbon resins, and natural resins. Express attention is drawn to the depiction of the state of knowledge in the “Handbook of Pressure Sensitive Adhesive Technology” by Donatas Satas (van Nostrand, 1989).

In a further preferred embodiment, reactive resins are added to the heat-activable adhesive.

One very preferred group embraces epoxy resins. The molecular weight M_{W} (weight average) of the epoxy resins varies from 100 g/mol up to a maximum of 10 000 g/mol for polymeric epoxy resins.

The epoxy resins embrace, for example, the reaction product of bisphenol A and epichlorohydrin, the reaction product of phenol and formaldehyde (novolak resins) and epichlorohydrin, glycidyl esters, the reaction product of epichlorohydrin and p-aminophenol.

Preferred commercial examples are Araldite™ 6010, CY-281™, ECN™ 1273, ECN™ 1280, MY 720, RD-2 from Ciba Geigy, DER™ 331, DER™ 732, DER™ 736, DEN™ 432, DEN™ 438, DEN™ 485 from Dow Chemical, Epon™ 812, 825, 826, 828, 830, 834, 836, 871, 872, 1001, 1004, 1031 etc. from Shell Chemical, and HPT™ 1071, HPT™ 1079 likewise from Shell Chemical.

Examples of commercial aliphatic epoxy resins are vinylcyclohexane dioxides, such as ERL-4206, ERL-4221, ERL 4201, ERL-4289 or ERL-0400 from Union Carbide Corp.

Examples of novolak resins which can be used include Epi-Rez™ 5132 from Celanese, ESCN-001 from Sumitomo Chemical, CY-281 from Ciba Geigy, DEN™ 431, DEN™ 438, Quatrex 5010 from Dow Chemical, RE 305S from Nippon Kayaku, Epiclon™ N673 from DaiNipon Ink Chemistry or Epicote™ 152 from Shell Chemical.

As reactive resins it is possible in addition to use melamine resins, such as Cymel™ 327 and 323 from Cytec.

As reactive resins it is also possible, furthermore, to use terpene-phenolic resins, such as NIREZ™ 2019 from Arizona Chemical.

As reactive resins it is also possible, furthermore, to use phenolic resins, such as YP 50 from Toto Kasei, PKHC from Union Carbide Corp., and BKR 2620 from Showa Union Gosei Corp.

As reactive resins it is also possible, furthermore, to use polyisocyanates, such as Coronate™ L from Nippon Polyurethan Ind. and Desmodur™ N3300 or Mondur™ 489 from Bayer.

In order to accelerate reaction between two components it is also possible, optionally, to additize crosslinkers and accelerants into the mixture.

Examples of suitable accelerants include imidazoles, available commercially as 2M7, 2E4MN, 2PZ-CN, 2PZ-CNS, P0505, L07N from Shikoku Chem. Corp. or Curezol 2MZ from Air Products.

In addition it is also possible to use amines, especially tertiary amines, for acceleration.

Besides reactive resins it is also possible to employ plasticizers. Here, in one preferred embodiment of the invention, plasticizers based on polyglycol ethers, polyethylene oxides, and phosphate esters can be used, as can aliphatic carboxylic esters and benzoic esters. In addition it is also possible to use aromatic carboxylic esters, diols of relatively high molecular mass, sulfonamides, and adipic esters.

A further possibility is to add optionally fillers (e.g., fibers, carbon black, zinc oxide, titanium dioxide, chalk, solid or hollow glass spheres, microspheres made of other materials, silica, silicates), nucleators, expandants, compounding agents and/or aging inhibitors, in the form for example of primary and secondary antioxidants or of light stabilizers.

In a further preferred embodiment of the pressure-sensitive adhesive tape of the invention use is made for layer i) of polyolefins, especially poly-α-olefins, which have a softening range of greater than 65°0 C. and less than 125° C. and which likewise resolidify after adhesive bonding, in the course of cooling. The company Degussa makes a number of different heat-activable poly-α-olefins available commercially under the trade name Vestoplast™.

In one preferred embodiment the polyolefin-activable adhesives have static softening temperatures T_{s,a} or melting points T_{m,a} of 65° C. to 125° C. The bond strength of these polymers can be raised by means of controlled additization. Thus it is possible, for example, to use polyimine copolymers or polyvinyl acetate copolymers as bond strength promoter additives.

### Production Process

For further processing for the adhesive bonding of electrical modules to card bodies, the heat-activable adhesive must be made available on a release paper or a release liner. Coating may take place from solution or, very preferably, from the melt. For application from the melt the solvent—if the polymer is in solution—is stripped off preferably in a concentrating extruder under reduced pressure, something which can be accomplished using, for example, single-screw or twin-screw extruders, which preferably distill off the solvent in different or identical vacuum stages and possess a feed preheater. Coating then takes place via a melt die or an extrusion die, with the film of adhesive being drawn if desired in order to achieve the optimum coating thickness. Blending of the resins can be carried out using a compounder or a twin-screw extruder for blending.

Backing materials used for the adhesive are the customary materials familiar to the skilled worker, such as films (polyesters, PET, PE, PP, BOPP, PVC, polyimide), nonwovens, foams, woven fabrics, and woven films, and also release paper (glassine, HDPE, LDPE). The backing materials ought to have been provided with a release layer. In one very preferred version of the invention the release layer is composed of a silicone release varnish or of a fluorinated release varnish.

### EXAMPLES

### Test Methods:

### Rheology A)

The measurement was carried out using a rheometer from Rheometrics Dynamic Systems (RDA II).

The Rheomatics Dynamical Analyser (RDA II) measures the torque which occurs when an oscillating shear is applied to a stripped sample (deformation control).

The sample diameter was 8 mm, the sample thickness between 1 and 2 mm. Measurement was carried out using the plate-on-plate configuration (parallel plates). The temperature sweep was recorded from 0 to 150° C. with a frequency of 10 rad/s.

### Iso-Bending B)

The Iso-bending test is carried out in analogy to the Iso/IEC standard 10373:1993 (E)—section 6.1. The test is passed if a total of more than 4000 bends is attained.

### Extreme Flexural Test C)

In the extreme flexural test a cutout 3 cm wide, with the electrical module lying in the center, is cut from the chip card and then pressed together 10×from a width of 3 cm to a width of 2.5 cm. The test is passed is the electrical module does not become detached.

### Hand Test D)

In the hand test the chip card is bent by hand over one of the two corners lying closer to the electrical module, to an extent such that the card breaks or the module breaks. The test in that case is passed. If the electrical module becomes detached or springs out, the test is failed.

### MFI E)

The melt flow index, MFI, was carried out in analogy to ISO 1133 (Procedure B, volume flow rate MVR). The test was carried out at 150° C. at 2.16 kg.

### Other Test Methods

Molar masses were determined by GPC (gel permeation chromatography) measurements. (Preparation of a solution of the sample in tetrahydrofuran with a concentration of 3 g/l; dissolution at room temperature for 12 hours; subsequently, filtration of the solution through a 1 μm disposable filter, addition of approximately 200 ppm of toluene as internal standard.

Using an autosampler, 20 μl of the solution are chromatographed as follows: a 10³⊕ column 50 mm long is followed by one 10⁶⊕, one 10⁴⊕, and one 10³⊕ column, each with a length of 300 mm. The eluent used is tetrahydrofuran, which is pumped at a flow rate of 1.0 ml/min. The columns are calibrated with polystyrene standards, detection taking place by the measurement of the change in refractive index with the aid of a Shodex differential refractometer RI 71).

The softening temperatures are determined preferably by way of differential scanning calorimetry (DSC).

### INVESTIGATIONS

### Reference 1)

Polyamide film XAF 34.408 from Collano-Xiro

### Reference 2)

PU film XAF 36.304 from Collano Xiro

### Example 1

Griltex 9 E (copolyester) from EMS-Grilltech+25% by weight EPR 0191 (epoxy resin, bisphenol A resin with 60° C. softening range) from Bakelite were blended in a recording compounder from Haake at approximately 130° C. for 15 minutes at 25 rpm. The heat-activable adhesive was subsequently extruded at 140° C. between two plies of siliconized glassine release paper to 60 μm.

According to test method E) the MFI was 30 cm³/10 minutes.

### Example 2

Griltex 9 E (copolyester) from EMS-Grilltech was extruded at 140° C. between two plies of siliconized glassine release paper to 60 μm. According to test method E) the MFI was 18 cm³/10 minutes.

### Example 3

Platamid 2395 (copolyamide) from Atofina+20% by weight EPR 0191 (epoxy resin, bisphenol A resin with 60° C. softening range) from Bakelite were blended in a recording compounder from Haake at approximately 130° C. for 15 minutes at 25 rpm. The heat-activable adhesive was subsequently extruded at 140° C. between two plies of siliconized glassine release paper to 60 μm.

According to test method E) the MFI was 16 cm³/10 minutes.

### Implantation of Electrical Modules

The electrical modules were implanted in the card body using an implanter from Ruhlamat.

The materials employed were as follows:

Electrical modules: Nedcard Dummy N4C-25C, Tape-Type: 0232-10 PVC card: CCD ABS card: ORGA

In a first step examples 1 to 3 are laminated at 2 bar onto the module belt from Nedcard, using a two-roll laminator from Storck GmbH.

The electrical modules are then implanted in the appropriate cavity in the card body.

The parameters employed were as follows for all the examples:
Heating step: 1
Die temperature: 150° C.
Time: 1×2 s
Cooling step: 1×800 ms, 25° C.
Pressure: 70 N per module

### RESULTS

The chip cards produced using the inventive adhesives were tested by methods B, C, and D. The results are set out in Table 1.

TABLE 1

| Examples | Test method B | Test method C | Test method D |
|---|---|---|---|
| 1 | passed | passed | passed |
| 2 | passed | passed | passed |
| 3 | passed | passed | passed |

From table 1 it is apparent that all of the inventive examples met the principal criteria for a chip card and hence are very suitable for adhesively bonding electrical modules to card bodies.

The rheological properties are listed in table 2 below.

TABLE 2

| Examples | G′ in [Pa] at 23° C. | G″ in [Pa] at 23° C. | Crossover |
|---|---|---|---|
| 1 | 1 × 10⁷ | 2.5 × 10⁶ | 110° C. |
| 2 | 1.3 × 10⁸ | 2.9 × 10⁷ | 120° C. |
| 3 | 1 × 10⁷ | 2.1 × 10⁶ | 108° C. |

1. An adhesive sheet of an adhesive system composed of a thermoplastic and optionally one or more resins, having
a) a softening temperature of greater than 65° C. and less than 125° C.,
b) a melt flow index (ISO 1133) of greater than 3 and less than 100 cm³/10 minutes,
c) a storage modulus G′ at 23° C., as measured by test method A, of greater than 10⁷ Pas,
d) a loss modulus G″ at 23° C., as measured by test method A, of greater than 10⁶ Pas,
e) and a crossover, as measured by test method A, of less than 125° C.

2. The adhesive sheet of claim 1, wherein the layer thickness is between 10 and 100 μm.

3. The adhesive sheet of claim 1, wherein said thermoplastic is selected from the group consisting of copolyamides, polyethyl-vinyl acetates, polyvinyl acetates, polyolefins, polyurethanes, and copolyesters.

4. The adhesive sheet of claim 1, wherein said resins are reactive resins comprising one or more members of the group consisting of epoxy resins, phenolic resins and novolak resins.

5. A method for bonding chip modules in card bodies which comprises bonding said chip modules in said card bodies with the adhesive sheet of claim 1.

6. The method of claim 5, wherein said chip modules are polyimide-, polyester or epoxy-based chip modules and said card bodies are PVC, ABS, PET, PC, PP or PE card bodies.

7. A method for producing a heat-activable adhesive tape, which comprises coating an adhesive system composed of a thermoplastic and optionally one or more resins, having
a) a softening temperature of greater than 65° C. and less than 125° C.
b) a melt flow index (ISO 1133) of greater than 3 and less than 100 cm³/10 minutes,
f) a storage modulus G′ at 23° C., as measured by test method A, of greater than 10⁷ Pas,
g) a loss modulus G″ at 23° C., as measured by test method A, of greater than 10⁶ Pas,
h) and a crossover, as measured by test method A, of less than 125° C. onto a release paper or a release film.

8. The adhesive sheet of claim 2, wherein said layer thickness is between 30 and 80 μm.
